(19) United States
(12) Patent Application Publication
(10) Pub. No.: US 2002/0188490 A1
(43) Pub. Date: Dec. 12, 2002

(54) Meeting scheduling/meeting room reservation linkage method

(76) Inventor: Patricia S. Kruse, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/880,398

(22) Filed: Jun. 12, 2001

(51) Int. Cl. G06F 17/60

(52) U.S. Cl. 705/8

(57) ABSTRACT

This invention relates to a method to link a calendaring system, such as an organize a meeting system, with a conference room/equipment reservation system. Such systems of this type, generally, allow the administrative assistants to schedule meetings, request equipment, and venues all at once instead of leaving one process (organize a meeting system) in midstream to connect to another program (reserve a conference room) as it is necessary to have the room reservation information included in the meeting invitation.

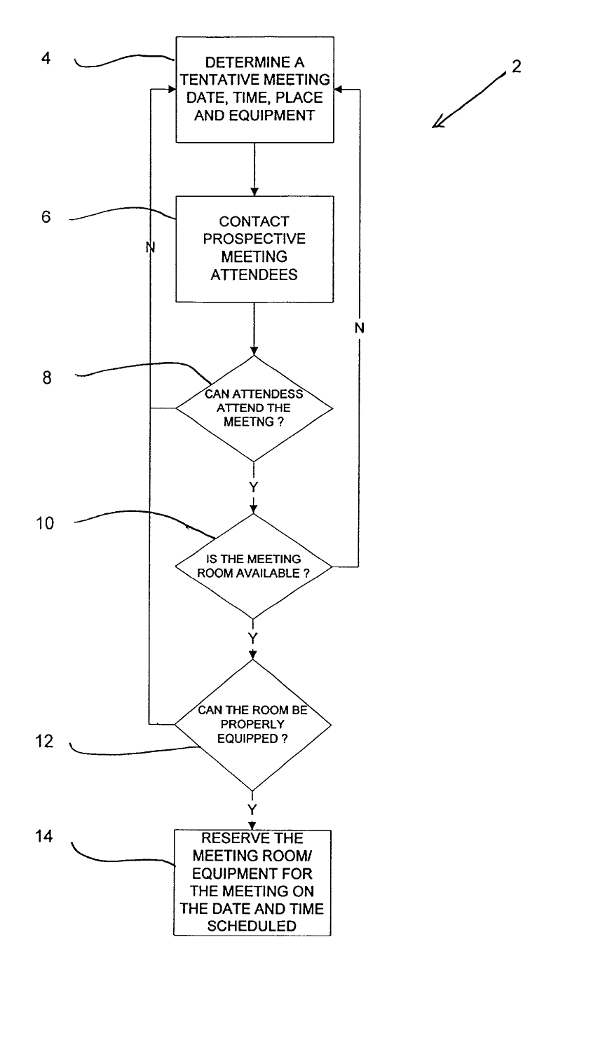

### FIELD OF THE INVENTION

This invention relates to a method to link a calendaring system, such as an organize a meeting system, with a conference room/equipment reservation system. Such systems of this type, generally, allow the administrative assistants to schedule meetings, request equipment, and venues all at once instead of leaving one process (organize a meeting system) in midstream to connect to another program (reserve a conference room) as it is necessary to have the room reservation information included in the meeting invitation.

### DESCRIPTION OF THE RELATED ART

It is known to schedule meetings electronically. Exemplary such prior art are U.S. Pat. No.4,626,836 ('836) to D. E. Curtis et al., entitled “Method of Scheduling Meetings,” U.S. Pat. No. 4,807,154 ('154) to K. J. Scully et al., entitled “Method for Developing Automatic Replies in an Interactive Electronic Calendaring System,” U.S. Pat. No. 4,831,552 ('552) to K. J. Scully et al., entitled “Method for Concurrently Displaying Entries From a Plurality of Different Electronic Calendars Based on Interactively Entered Non-temporal Criteria,” and U.S. Pat. No. 4,977,520 ('520) to H. S. McGaughey, III et al., entitled “Method to Facilitate a Reply to Electronic Meeting Invitation in an Interactive Multi-terminal System Employing Electronic Calendars.” While these references teach systems that are capable of electronically scheduling a meeting, a more advantageous system, then, would be presented if the system could also reserve the meeting room and equipment.

It is also known to be able to schedule meetings and reserve meeting rooms electronically. The current solution is to use a calendaring system that has an organize a meeting function to find the available times for meeting attendees, then go into a separate Web-based room reservation system to find a room that is available at that time. The disadvantage of this technique is having to halt the meeting scheduling process, opening a Web browser, logging in to the room reservation system, searching for a room, reserving it, then going back and finally scheduling the meeting.

It is apparent from the above that there exists a need in the art for a system which is capable of scheduling meetings, but which at the same time is capable of reserving the meeting room and equipment without having to halt the meeting scheduling process. It is a purpose of this invention to fulfill this and another needs in the art in a manner more apparent to the skilled artisan once given the following disclosure.

### SUMMARY OF THE INVENTION

Generally speaking, this invention fulfills these needs by providing a method for meeting scheduling/meeting room reservations, comprising the steps of: determining a tentatively, scheduled date, time and place to hold a meeting; concurrently contacting prospective meeting attendees and meeting places; concurrently determining if the meeting attendees can attend the tentatively, scheduled meeting and if a desired meeting room is available; and reserving the meeting room for the scheduled meeting time and date.

In certain preferred embodiments, the desired meeting room can be made one of the prospective meeting attendees. Also, the system can be Web-based. Finally, the method includes a process for determining if the desired meeting room equipment will be available.

In another further preferred embodiment, administrative assistants can more easily plan meetings and reserve rooms/equipment without having to interact back and forth between a variety of meeting scheduling programs and meeting room/equipment reservation programs.

The preferred system, according to this invention, offers the following advantages: ease of planning meetings; ease of reserving meeting rooms; ease of reserving meeting equipment; increased efficiency; and excellent economy. In fact, in many of the preferred embodiments, these factors of ease of planning meetings, ease of reserving meeting rooms, ease of reserving meeting equipment, efficiency, and economy are optimized to an extent that is considerably higher than heretofore achieved in prior, known systems.

The above and other features of the present invention, which will become more apparent as the description proceeds, are best understood by considering the following detailed description in conjunction with the accompanying drawing FIGURE, and in which:

### BRIEF DESCRIPTION OF THE DRAWING

The FIGURE is a flowchart that illustrates a meeting scheduling/meeting room reservation linkage system, according to one embodiment of the present invention.

### DETAILED DESCRIPTION OF THE INVENTION

With reference to the FIGURE, there is illustrated one preferred embodiment for use of the concepts of this invention. Method 2 for a meeting scheduling/meeting room reservation linkage is illustrated. Method 2 includes, in part, the steps of determining a tentative meeting date, time, place, and equipment 4, contacting prospective meeting attendees 6, determining if attendees can attend the meeting 8, determining if the meeting room is available 10, determining if the meeting room can be properly equipped 12, and reserving the meeting room/equipment for the meeting on the date and time scheduled 14. It is to be understood that method 2 can be Web-based. In this manner, the various components (attendee calendar, meeting room availability, and meeting equipment availability) can be searched by a conventional browser and compiled in a conventional computing device.

With respect to step 6, it is to be understood that in one preferred embodiment, the meeting room/equipment can be referred to as meeting attendees in order to determine if the meeting room/equipment will be available on the tentative meeting date and time.

With respect to step 8, method 2 can determine the availability of the attendees by electronically checking the calendars of the prospective attendees.

With respect to step 10, method 2 can also determined the availability of the meeting room by electronically checking the calendar of the desired meeting room.

With respect to step 12, method 2 can review a conventional facilities checklist of the desired meeting room to make sure that the desired meeting room is equipped with the desired equipment. For example, it may be desired that a videoconference be held during the meeting. Consequently, videoconferencing equipment must be made available in that meeting room on the desired day. It is to be understood that method 2 can also review a conventional facilities checklist of the entire site where the meeting is to be held and request that the proper equipment be delivered to be desired room on the scheduled date and time.

With respect to steps 6, 8, 10 and 12, the steps are done concurrently. In this manner, method 2 contacts the attendees, the meeting room reservation system, and the meeting room equipment system, all at once, in order to organize the meeting time and date and reserve the meeting room and equipment. If there is a conflict with one or more of the attendees making the meeting, the availability of the meeting room or the availability of the meeting room equipment, method 2 automatically attempts to determine another tentative meeting date, time, equipment and place until such a meeting date, time, equipment and place are agreed upon.

After the meeting date, time, equipment and place are agreed upon, the meeting room/meeting equipment are reserved for the meeting time and place and the attendees are notified of the meeting date, time, equipment, and place, as shown in step 14.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for meeting scheduling/meeting room reservations, wherein said method is comprised of the steps of:
determining a tentatively scheduled date, time and place to hold a meeting;
concurrently contacting prospective meeting attendees and meeting places;
concurrently determining if said meeting attendees can attend the tentatively scheduled meeting and if a desired meeting room is available; and
reserving said desired meeting room for said scheduled meeting time and date.

2. The method, as in claim 1, wherein said determining step is further comprised of the step of:
determining a desired equipment to be used at said meeting.

3. The method, as in claim 1, wherein said concurrently contacting step is further comprised of step of:
concurrently contacting an equipment facilities checklist.

4. The method, as in claim 2, wherein said concurrently determining step is further comprised of step of:
concurrently determining if said desired equipment will be available.

5. The method, as in claim 1, wherein said concurrently contacting step is further comprised of the step of:
designating said meeting place as an attendee.

6. The method, as in claim 2, wherein said concurrently contacting step is further comprised of the step of:
designating said desired equipment as an attendee.

7. The method, as in claim 1, wherein said method is further comprised of the step of:
notifying said attendees of said scheduled meeting time and place.

8. The method, as in claim 2, wherein said method is further comprised of the step of:
notifying said attendees that said desired equipment will be available at said desired meeting room on said scheduled meeting time and date.
